(19) United States
(12) Patent Application Publication
(10) Pub. No.: US 2011/0231393 A1
(43) Pub. Date: Sep. 22, 2011

(54) Determining Presence Of A User In An Online Environment

(75) Inventors: Shankar Hebbale Narasimhiah, Karnataka (IN); Venkatesha Prasad Rangarao, Karnataka (IN); Vijay Satyanarayana Rao, Karnataka (IN); Muralishankar Rangarao, Karnataka (IN)

(73) Assignee: PES Institute of Technology

(21) Appl. No.: 12/664,888

(22) PCT Filed: Dec. 29, 2008
(86) PCT No.: PCT/IN2008/000875

§ 371 Date: Dec. 16, 2009

(51) Int. Cl. G06F 17/30

(52) U.S. Cl. 707/723; 707/E17.014

(57) ABSTRACT

Disclosed herein is a computer implemented method and system for determining presence of a first user by a second user in an online environment. The first user provides the first user's profile information and characteristic information. The first user marks keywords in the characteristic information. The first user marks the keywords based on inference of second user's knowledge about the first user. The marked keywords are categorized into predefined categories. The second user provides search words. The search words are compared with the characteristic information and the keywords to find matches. The matches are weighted. Search indexes are generated for the weighted matches based on a predetermined criterion. The weighted matches with the generated search indexes are provided to the second user. The selected profile information corresponding to the predefined categories comprising the categorized keywords for which the weighted matches have high search indexes, is displayed to the second user.

### BACKGROUND

This invention, in general, relates to online networking and online social networking. More particularly, this invention relates to determining the presence of a first user by a second user in an online environment.

Often persons lose contact with friends and acquaintances who relocate to different places or even to different jobs in the same city. Keeping friends and acquaintances informed and updated about changes in addresses or phone numbers or both of a relocation may be cumbersome. Getting in touch with an acquaintance with whom a person has lost contact without going through a mutual friend or without knowledge of the acquaintance's current location is difficult. Hence, there is a need for finding people by providing references to events in their life and their interactions with other people. Using facts and incidents revealed and shared by two users directly or indirectly in an online environment may provide a means to track the online presence of a person.

Several applications on the Internet provide a place where the virtual presence of people is available in some form or the other. The applications may, for example, be social networking websites. Some people are actively online, for example when they use instant messaging services and others are passively contactable through websites, web pages, online profiles, and blogs where they share personal details. People do not usually make their personal interactions with others known to everyone. Also, people usually do not keep their addresses and phone numbers publicly visible, but share them with people with whom they may have had or envisage to have close interaction. People also have preferences regarding the contact information to be disclosed to others. For example, while electronic mail (email) addresses may be openly displayed, home or mobile numbers may not be shared with strangers.

Social networking websites currently allow users in the social network to search for other specific users based on the personal information provided by the users. However, the information on these websites is limited and mostly relates to the events associated with the users moderated by the dispositions and preferences of the users. For example, it is difficult to find a childhood friend online without knowing the friend's current profession or current location. There is a need to keep a record of past events and interactions in the user's life that may help in identification of the user by acquaintances.

Blogging service providers allow users to publish content which may include text, images, multimedia, and animation on a website. Users typically use the blogging services to maintain records of past events and interactions. The content on the blog may be publicly accessible to the public, or to a select few invited people, or only to the author of the blog. Often, a blog is maintained under an alias, making it difficult to determine the identity of the author. The blogging services do not allow searching based on name, events, and the blog content. Web search engines have restricted access to publicly accessible blogs and hence search results are not comprehensive. There is a need to provide a search application that efficiently identifies a specific user through keywords based on content, past events, interactions with acquaintances, etc., while ensuring privacy, confidentiality, and security of the user's information.

Hence, there is an unmet need for a computer implemented method and system for determining the presence of a first user by a second user in an online environment, based on knowledge of past events, past interactions, etc. Furthermore, there is a need for a computer implemented method and system that allows the second user to contact the first user without the complete identity of the first user being revealed by the first user.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein address the above stated needs for determining the presence of a first user by a second user in an online environment based on knowledge of past events, interests, and past interactions between the first user and the second user. As used herein, determining the presence of a first user refers to identifying the current location, whereabouts, and other information of the first user. The computer implemented method and system further discloses information of the first user according to the first user's preferences, thereby ensuring privacy, confidentiality, and security of the first user's information. The computer implemented method and system allows the second user to contact the first user without the complete identity of the first user being revealed by the first user.

The first user may register with an online environment that allows users to store profile information and characteristic information. The online environment may, for example, be an online social network. The first user provides the first user's profile information with or without keywords in the online environment. The first user provides the first user's characteristic information in the online environment. The characteristic information is associated with personal events, past events, interactions, and interests of the first user. The characteristic information may, for example, be personal information, public information, or private information. The first user marks one or more keywords in the characteristic information based on the first user's inference of the second user's knowledge about the first user. The first user may select a visibility type for the characteristic information. The visibility type may be completely private, completely public, and partially public. The partially public visibility type allows only the invitees of the first user to view the characteristic information.

One or more of the marked keywords are categorized into predefined categories. The first user selects part of the profile information corresponding to the predefined categories to be displayed to the second user. The second user may provide one or more search words for determining the presence of the first user in the online environment. The search words are compared with the characteristic information and the keywords to find matches. The search words are compared with the characteristic information and the keywords of every registered user in the online environment, irrespective of the visibility type of the characteristic information. The comparison of the search words with the categorized keywords comprises automatic identification of the marked keywords in the characteristic information of the first user.

The second user is notified when the matches are found. The matches are weighted based on matching of the search words with the categorized keywords. The matches found with the categorized keywords are given a higher weight than the matches found with unmarked keywords. Search indexes for the weighted matches are generated based on a predetermined criterion. The predetermined criterion for generating the search indexes may, for example, be based on number of search words provided by the second user, number of search words matching the categorized keywords, and the visibility types of the characteristic information of the first user. The generated search indexes determine the parts of the characteristic information to be displayed to the second user based on visibility types of the characteristic information selected by the first user. The generated search indexes may also be graded and normalized based on the number of the search words provided by the second user and number of the search words matched with the categorized keywords.

The weighted matches with the generated search indexes are provided to the second user. The weighted matches are provided to the second user only if the number of the weighted matches is below a predefined value. The predefined value represents a maximum number of weighted matches required by the second user to determine the presence of the first user from the weighted matches. If the number of the weighted matches exceeds the predefined value, the second user may be prompted to provide additional search words based on the second user's knowledge about the first user. Providing additional keywords may reduce the number of weighted matches, thereby enabling the second user to determine the presence of the first user. The second user is allowed to provide the additional search words for a predefined number of iterations. The weighted matches may be provided to the second user when a predefined number of the search words matches the categorized keywords. The predefined number may be set by the first user.

Best matched categories may be determined prior to providing the weighted matches to the second user. The best matched categories are those categories comprising the categorized keywords for which the weighted matches have high search indexes. The selected profile information corresponding to the best matched categories is displayed to the second user. Multiple categories may have the same number of matches of search words with the categorized keywords, in which case, the profile information under these categories is displayed to the second user. The profile information and characteristic information marked as private by the first user are not displayed to the second user.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein,

FIG. 1 illustrates a computer implemented method of determining presence of a first user by a second user in an online environment.

FIG. 2 illustrates a computer implemented system for determining presence of a first user by a second user in an online environment.

### DETAILED DESCRIPTION OF THE INVENTION

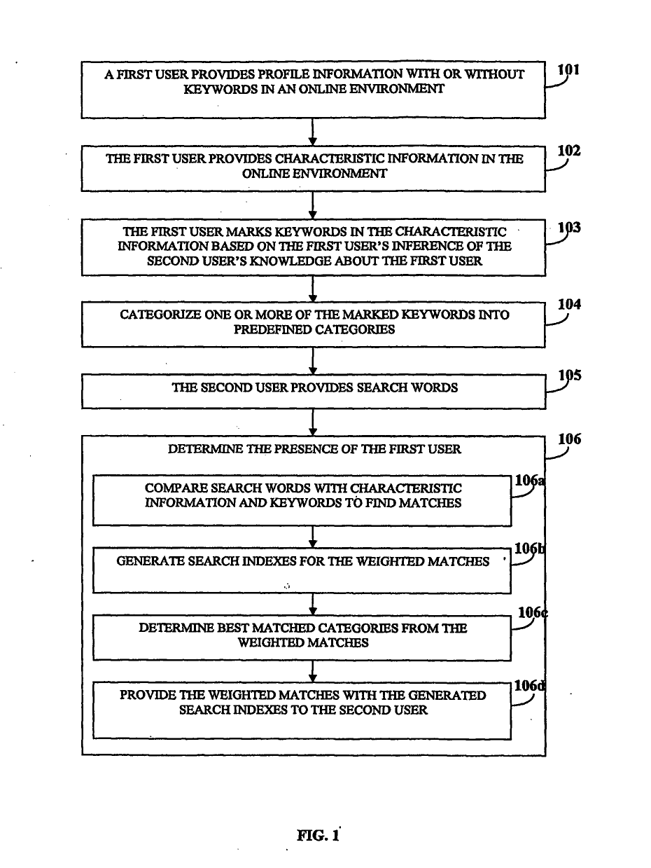

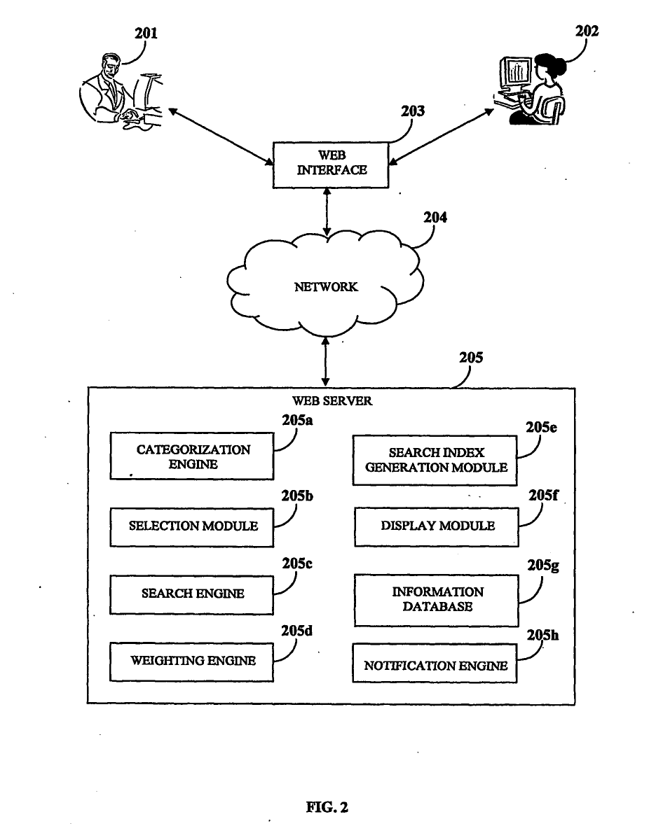

FIG. 1 illustrates a computer implemented method of determining the presence of a first user 201 by a second user 202 in an online environment. As used herein, the “first user” refers to the user being searched for and the “second user” refers to the user searching for the first user 201. The online environment may be, for example, an online social network. The online environment may comprise a web server 205 which hosts a website. The first user 201 and the second user 202 may access the website hosted on the web server 205 via a network 204 as illustrated in FIG. 2. The first user 201 provides 101 profile information with or without keywords in the online environment. The profile information comprises contact details and personal information of the first user 201. The personal information comprises preferences of the first user 201, interests, likes and dislikes of the first user 201, etc.

The first user 201 also provides 102 characteristic information in the online environment. The characteristic information is associated with personal events, past events, interactions, and interests of the first user 201. The characteristic information may, for example, be personal information, public information, or private information. The characteristic information may comprise articles and write ups relating to the first user's 201 memories, incidents in the first user's 201 life, the first user's 201 knowledge about topics and incidents, and the first user's 201 interactions with other people. The characteristic information may further comprise the first user's 201 past workplace information, information on schools of education, information on friends, etc.

The first user 201 marks 103 one or more keywords in the characteristic information that may be used as search words by the second user 202 wishing to locate the first user 201 in the online environment. The first user 201 may also mark keywords in the profile information. The first user 201 marks the keywords based on the first user's 201 inference of the second user's 202 knowledge about the first user 201. The personal information and the profile information are stored in an information database 205g.

The first user 201 may select one of multiple visibility types for the profile information and the characteristic information of the first user 201. For example, the visibility type for the profile information and characteristic information may comprise a “completely private” visibility type, a “completely public” visibility type, or a “partially public” visibility type within the visibility types. The profile information and the characteristic information set as “completely private” may not be displayed to the second user 202. The profile information and the characteristic information set as “completely public” may be displayed to the second user 202. The first user 201 may choose to permit specific parts of the profile information and the characteristic information. The profile information and the characteristic information set as “partially public” allows specific parts of the profile information and the characteristic information to be viewed by a specific second user 202.

The first user 201 may edit or add the profile information and characteristic information in the online environment by logging onto the website hosted on the web server 205. The first user 201 may also edit the profile information and the characteristic information by sending an electronic mail (email) from an email address previously verified in the online environment, or by sending a message from a cellular phone number previously verified in the online environment.

One or more of the marked keywords may be categorized 104 into predefined categories. The predefined categories may be labeled, for example, as personal, school, job, relatives, and friends. Each of the marked keywords is labeled in the predefined categories. The first user 201 may also enter profile information corresponding to each of the predefined categories. The first user 201 selects part of the profile information corresponding to the predefined categories to be displayed to the second user 202.

The second user 202 who wishes to determine the presence of the first user 201 in the online environment, provides 105 one or more search words on the website hosted on the web server 205 in the online environment. The search words may, for example, be words or phrases that the second user 202 associates with the first user 201. The search words may also be words or phrases mentioned in the profile information or the characteristic information provided by the first user 201.

The web server 205 in the online environment performs a search to determine 106 the presence of the first user 201. The marked keywords in the characteristic information of the first user 201 may be automatically identified. The search words provided by the second user 202 are compared 106a with the characteristic information and the keywords of the users in the online environment, irrespective of the visibility types of the characteristic information to find matches. The profile information and characteristic information of the users in the online environment are searched, including profile information and characteristic information of the “completely public” visibility type, the “completely private” visibility type, and the “partially public” visibility type. The second user 202 may be notified on finding the matches via, for example, an email message or a cellular phone message.

The matches found with the categorized keywords are given a higher weight than the matches found with unmarked keywords. The matches are weighted based on matching of the search words with the categorized keywords. The first user 201 may also specify weights for the marked keywords based on which the matches found will be weighted. The weighted matches are provided to the second user 202 if the number of the weighted matches is below a predefined value. If the number of the weighted matches exceeds the predefined value, the second user 202 is prompted to provide additional search words based on the second user's 202 knowledge about the first user 201. The second user 202 is allowed to provide the additional search words for a predefined number of iterations. The weighted matches are provided to the second user 202 when a predefined number of the search words matches with the categorized keywords. The predefined number is set by the first user 201.

Search indexes are generated 106b for every user whose marked keywords match with the search words. The search indexes are generated for each of the weighted matches based on a predetermined criterion. The predetermined criterion may, for example, be based on number of search words provided by the second user 202, the number of the search words matching the categorized keywords, and the visibility types of the characteristic information selected by the first user 201.

The search indexes may be graded and normalized based on number of the search words provided by the second user 202 and number of the search words matched with the categorized keywords. Grading is used to match the keywords and find the matches with different visibility types. The matches in different visibility types are permitted to have different weights. For example, the matches in the “private” section will have higher weights. The matches in different categories are then normalized to find a number that will be used to decide whether the second user 202 should be provided with the profile information of the first user 201.

The searching and matching algorithms consider the number of keywords or sentences that match the information in the “completely private”, “completely public” and “partially public” visibility types, the correlation of the keywords in each of the categories and the search words specified by the second user 202 based on the sequence in which they appear, and the search index with respect to matches which depend also on the number of keywords and the amount of information available in the profile of the first user 201. The specific matches in the three visibility types may be permitted to have non identical weights. The searching and matching algorithms result in a figure of merit that will be used to connect the first user 201 with second user 202 after the matching.

The weighted matches with the generated search indexes are provided 106d to the second user 202. Best matched categories may be determined 106c prior to providing the weighted matches to the second user 202. The best matched categories are those categories comprising the categorized keywords for which the weighted matches have high search indexes. The selected profile information corresponding to the best matched categories is displayed to the second user 202. Multiple categories may have the same number of matches of search words with the categorized keywords, in which case, the profile information under these categories is displayed to the second user 202.

The profile information and characteristic information set as “private” by the first user 201 is not revealed to the second user 202. The profile information and characteristic information of the first user 201 may be shown to the second user 202 or may be sent to an email account of the second user 202. The generated search indexes determine parts of the characteristic information to be displayed to the second user 202 based on visibility types of the characteristic information selected by the first user 201.

If the number of the weighted matches exceeds the predefined value, the second user 202 is prompted to provide additional search words based on the second user's 202 knowledge about the first user 201. For example, the weighted matches may be provided to the second user 202 only if the number of weighted matches is below a certain number N based on an algorithm. On exceeding N weighted matches, the second user 202 may be prompted to provide additional search words based on the second user's 202 knowledge about the first user 201 if the information cannot be displayed with N.

If the number of the weighted matches exceeds a predefined value N, the second user 202 is prompted to provide additional search words. The second user 202 is allowed to provide the additional search words for a predefined number of iterations. The predefined number of iterations is exemplarily represented by R. R may be a finite positive integer not less than one and may be predefined by an administrator in the online environment. The administrator may further define an upper boundary U and a lower boundary L for the number of the search words provided by the second user 202. U may be a finite positive integer and L may be an integer greater than 1 and less than U. If the number of search words provided by the second user 202 is less than L or is greater than U, the second user 202 is notified and instructed to provide a number of search words greater than L and lower than U. After R iterations of providing the additional search words, if the number of weighted matches still exceeds N, the second user 202 or the Internet protocol (IP) address of a computing device used by the second user 202 to access the website hosted on the web server 205 may temporarily be disallowed from searching further for the first user 201.

If the number of weighted matches is zero, the second user 202 may be unable to determine the presence of the first user 201 using the search words provided. After R iterations to determine the presence of the first user 201, the second user 202 is notified of a failure to determine the presence of the first user 201 and the search process is terminated.

FIG. 2 illustrates a computer implemented system for determining presence of a first user 201 by a second user 202 in an online environment The computer implemented system disclosed herein comprises a web interface 203 and a web server 205 connected via a network 204 in the online environment. The web server 205 comprises a categorization engine 205a, a selection module 205b, a search engine 205c, a weighting engine 205d, a search index generation module 205e, a display module 205f, an information database 205g, and a notification engine 205h.

The first user 201 provides profile information and characteristic information on the online environment using the web interface 203. The profile information and characteristic information of the first user 201 are stored in the information database 205g. The selection module 205b enables the first user 201 to select one of the visibility types for the characteristic information. The first user 201 may mark keywords in the characteristic information using the web interface 203. The first user 201 may also mark keywords in the profile information. The categorization engine 205a enables the first user 201 to categorize one or more of the marked keywords into predefined categories. The predefined categories may be labeled, for example, as personal, school, job, relatives, and friends. The selection module 205b enables the first user 201 to select part of the profile information corresponding to the predefined categories to be displayed to the second user 202.

The second user 202 provides search words in the online environment for determining the presence of the first user 201. The search engine 205c compares the search words provided by the second user 202 with the characteristic information and the keywords to find matches. The search engine 205c automatically identifies the marked keywords in the characteristic information of the first user 201 for the comparison with the search words. The search engine 205c searches the profile information and characteristic information provided by the users in the online environment, including the information set as “completely private”, “completely public”, and “partially public” visibility types. The notification engine 205h may notify the second user 202 on finding the matches. The weighting engine 205d weights the matches based on matching of the search words with the categorized keywords. The notification engine 205h may send a notification of the weighted matches to the second user 202 via, for example; an email message or a cellular phone message.

The search index generation module 205e generates search indexes for the weighted matches based on a predetermined criterion. The predetermined criterion may, for example, be based on the number of search words provided by the second user 202, the number of search words matching the categorized keywords, and the visibility types of the characteristic information of the first user 201. The search index generation module 205e uses the generated search indexes to determine the parts of the characteristic information to be displayed to the second user 202 based on the visibility types of the characteristic information. The search index generation module 205e may use the searching and matching algorithms for grading and normalizing the generated search indexes based on number of the search words provided by the second user 202 and number of the search words matched with the categorized keywords.

The display module 205f provides the weighted matches with the generated search indexes to the second user 202 via the web interface 203. The display module 205f displays the selected profile information corresponding to the predefined categories comprising the categorized keywords for which the weighted matches have high search indexes to the second user 202. The display module 205f displays the profile information corresponding to the best matched categories. Therefore, if multiple categories have the same number of matches of search words with the categorized keywords, the display module 205f will display the profile information under these categories to the second user 202. The display module 205f provides the weighted matches to the second user 202 if the number of weighted matches is below a predefined value. If the number of weighted matches exceeds the predefined value, the search engine 205c prompts the second user 202 to provide additional search words based on the second user's 202 knowledge about the first user 201. The search engine 205c allows the second user 202 to provide the additional search words for a predefined number of iterations as explained in the detailed description of FIG. 1. The display module 205f may also provide the weighted matches to the second user 202 when a predefined percentage of the search words matches with the marked keywords. The display module 205f provides the weighted matches to the second user 202 when a predefined number of the search words matches with the categorized keywords.

The second user 202 may also be mapped to the first user 201 based on a combination of the search words and the exclusivity of the second user 202 who is searching the first user 201. For example, the system knows who the second user 202 is and if the search keywords used are exclusively listed by the first user 201 for the second user 202 relating an incident involving both the users, then the second user 202 would be matched to the first user 201 directly and allowed to share the information with each other.

Consider an example of a first user 201, Bob. Bob signs up to become a member in an online environment, for example, an online social network. Bob provides his profile information on the online social network. He sets the visibility type of his information. For example, Bob sets the visibility type for the characteristic information to “public”. He then provides his characteristic information, comprising articles describing events and marks keywords that he thinks only the people who know him will use to locate him. The articles may be about his childhood memories or events from his previous jobs. Bob marks keywords such as the school he attended, the company he works for and names of colleagues from his previous jobs. Bob categorizes the marked keywords into predefined categories. For example, he labels the keywords “school” and “childhood memories” as a “personal” category. He categorizes the marked keywords corresponding to his job as “professional”. For each category, Bob enters the corresponding profile information to be displayed. The more the details Bob provides, the greater the likelihood of him being located.

A second user 202, Jane, who wishes to find Bob, logs on to the online social network and enters a few search words that may be mentioned in Bob's profile information or characteristic information, based on her knowledge about Bob. The search matches and lists a few entries of users of the online social network who have the keywords in their articles. If Jane knows him professionally, she enters the search words mostly pertaining to events at his job. If she knows him from school, she enters the search words mostly pertaining to events at his school. If the search words match many profiles, then Jane may, for example, be asked to enter search words specific to Bob that may comprise the name of his school and the names of his teachers. When she has located Bob, she is given the contact details that Bob wishes to share. To select the profile information to display, if the best matched category was “personal”, she gets Bob's personal contact details. If most of her search words matched Bob's keywords categorized as “professional”, she gets Bob's professional contact details. Bob's contact details may either be displayed to her through the web interface 203, or emailed to her email address stored on the web server 205. Jane thereby determines the presence of Bob in the online social network.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for example, computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory. Volatile media include Dynamic Random Access Memory (DRAM), which typically constitutes the main memory. Transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, XML, AJAX, HTML, and JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the information database 205g, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes described herein. Optimization for storing the databases and generating faster search indexes may be employed based on the availability. Any algorithms for searching may be web-based, and be employed without loss of generality. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Virtual Local Area Network (VLAN), Wide Area Network (WAN) or Ethernet, Token Ring, or via any appropriate communications means or combination of communications means. Each of the devices may comprise computers, personal digital assistants (PDAs), mobile phones, hand-held mobile devices, devices with user interfaces, such as those based on the Intel® processors, AMD® processors, Sun® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention hag been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as am within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of determining presence of a first user by a second user in an online environment, comprising the steps of:
providing profile information of said first user in said online environment;
providing characteristic information by the first user in the online environment, wherein the first user marks one or more of a plurality of keywords in said characteristic information based on inference of knowledge possessed by said second user about the first user;
categorizing one or more of said marked keywords into predefined categories, wherein the first user selects part of said profile information corresponding to said predefined categories to be displayed to the second user;
providing one or more of a plurality of search words by the second user;
comparing said search words with said characteristic information and said keywords to find matches, wherein said matches are weighted based on matching of the search words with said categorized keywords;
generating search indexes for said weighted matches based on a predetermined criterion; and
providing the weighted matches with said generated search indexes to the second user, wherein said selected profile information corresponding to the predefined categories comprising the categorized keywords for which the weighted matches have high search indexes, is displayed to the second user;
whereby the second user determines said presence of the first user in the online environment.

2. The computer implemented method of claim 1, further comprising the step of selecting one of a plurality of visibility types for the characteristic information by the first user.

3. The computer implemented method of claim 1, wherein the characteristic information is associated with personal events, past events, interactions, and interests of the first user.

4. The computer implemented method of claim 1, wherein said predetermined criterion for generating said search indexes is based on number of search words provided by the second user, number of search words matching the categorized keywords, and visibility types of the characteristic information of the first user.

5. The computer implemented method of claim 1, wherein the generated search indexes determine parts of the characteristic information to be displayed to the second user based on visibility types of the characteristic information selected by the first user.

6. The computer implemented method of claim 1, further comprising the step of grading and normalizing the generated search indexes based on number of the search words provided by the second user and number of the search words matched with the categorized keywords.

7. The computer implemented method of claim 1, wherein said step of comparing the search words with the categorized keywords comprises automatic identification of the marked keywords in the characteristic information of the first user.

8. The computer implemented method of claim 1, wherein the weighted matches are provided to the second user if number of the weighted matches is below a predefined value.

9. The computer implemented method of claim 8, further comprising the step of prompting the second user to provide additional search words based on said knowledge possessed by the second user about the first user when number of the weighted matches exceeds said predefined value.

10. The computer implemented method of claim 9, wherein the second user is allowed to provide said additional search words for a predefined number of iterations.

11. The computer implemented method of claim 1, wherein the weighted matches are provided to the second user when a predefined number of the search words matches with the categorized keywords, wherein said predefined number is set by the first user.

12. The computer implemented method of claim 1, wherein the matches found with the categorized keywords are given a higher weight than the matches found with unmarked keywords.

13. The computer implemented method of claim 1, further comprising a step of notifying the second user on finding the matches.

14. A computer implemented system for determining presence of a first user by a second user in an online environment, comprising:
a web interface for enabling said first user to provide profile information and characteristic information in said online environment, wherein the first user marks one or more of a plurality of keywords in said characteristic information using said web interface;
a web server, comprising:
a categorization engine for enabling the first user to categorize one or more of said marked keywords into predefined categories;
a selection module for enabling the first user to select part of said profile information corresponding to said predefined categories to be displayed to the second user;
a search engine for comparing search words provided by said second user with said characteristic information and said keywords to find matches;
a weighting engine for weighting said matches based on matching of the search words with said categorized keywords; and
a search index generation module for generating search indexes for said weighted matches based on a predetermined criterion, wherein said predetermined criterion is based on number of said search words provided by the second user, number of the search words matching the categorized keywords, and visibility types of the characteristic information of the first user.

15. The computer implemented system of claim 14, wherein said web server further comprises a display module for providing the weighted matches with said generated search indexes to the second user, wherein said display module displays said selected profile information corresponding to the predefined categories comprising the categorized keywords for which the weighted matches have high search indexes to the second user.

16. The computer implemented system of claim 15, wherein the display module provides the weighted matches to the second user if number of the weighted matches is below a predefined value.

17. The computer implemented system of claim 16, wherein the search engine prompts the second user to provide additional search words based on knowledge about the first user if number of the weighted matches exceeds said predefined value, wherein the search engine allows the second user to provide said additional search words for a predefined number of iterations.

18. The computer implemented system of claim 15, wherein the display module provides the weighted matches to the second user when a predefined number of the search words matches with the categorized keywords.

19. The computer implemented system of claim 14, wherein said selection module enables the first user to select one of said visibility types for the characteristic information, wherein the characteristic information is associated with personal events, past events, interactions, and interests of the first user.

20. The computer implemented system of claim 14, wherein said web server further comprises an information database for storing the profile information and the characteristic information of the first user.

21. The computer implemented system of claim 14, wherein said search index generation module uses said generated search indexes to determine parts of the characteristic information to be displayed to the second user based on said visibility types of the characteristic information.

22. The computer implemented system of claim 14, wherein said search index generation module grades and normalizes said generated search indexes based on number of the search words provided by the second user and number of the search words matched with the categorized keywords.

23. The computer implemented system of claim 14, wherein said search engine automatically identifies the marked keywords in the characteristic information of the first user for said comparison with the search words.

24. The computer implemented system of claim 14, wherein said web server further comprises a notification engine for notifying the second user on finding the matches.

25. A computer program product comprising computer executable instructions embodied in a computer-readable medium, wherein said computer program product comprises:
a first computer parsable program code for obtaining profile information provided by a first user in an online environment;
a second computer parsable program code for obtaining characteristic information provided by said first user in said online environment;
a third computer parsable program code for enabling the first user to mark one or more of a plurality of keywords in said characteristic information based on inference of knowledge possessed by a second user about the first user;
a fourth computer parsable program code for categorizing one or more of said marked keywords into predefined categories, wherein the first user selects part of said profile information corresponding to said predefined categories to be displayed to said second user;
a fifth computer parsable program code for obtaining one or more of a plurality of search words provided by the second user;
a sixth computer parsable program code for comparing said search words with said characteristic information and said keywords to find matches;
a seventh computer parsable program code for weighting said matches based on matching of the search words with said categorized keywords;
an eighth computer parsable program code for generating search indexes for said weighted matches based on a predetermined criterion;
a ninth computer parsable program code for providing the weighted matches with said generated search index to the second user, and
a tenth computer parsable program code for displaying said selected profile information corresponding to the predefined categories comprising the categorized keywords for which the weighted matches have high search indexes to the second user.
